(19) United States
(12) Patent Application Publication
(10) Pub. No.: US 2011/0037779 A1
(43) Pub. Date: Feb. 17, 2011

(54) LARGE SIZE IMAGE BROWSING APPARATUS AND METHOD THEREOF

(75) Inventor: HUI-WEI LIANG, SHANGHAI (CN)

Correspondence Address: WPAT, PC;INTELLECTUAL PROPERTY ATTORNEYS, 2030 MAIN STREET, SUITE 1300, IRVINE, CA, 92614, US

(73) Assignees: MITAC INTERNATIONAL CORP., Taoyuan (TW); MITAC RESEARCH (SHANGHAI) LTD., SHANGHAI (CN)

(21) Appl. No.: 12/700,740

(22) Filed: Feb. 5, 2010

(30) Foreign Application Priority Data
Aug. 11, 2009 (TW) 098127032

(51) Int. Cl. G09G 5/00

(52) U.S. Cl. 345/661; 345/156; 345/676

(57) ABSTRACT

The present invention discloses a large size image browsing apparatus and a method thereof. The large size image browsing method according to the present invention comprises the following steps. First, a browsing apparatus is moved. Next, a sensing unit senses the force exerted on the browsing apparatus and calculates the displacement of the browsing apparatus to send out a displacement signal. Then, a processing unit sends out a control signal according to the displacement signal to update a part of the large size image on a display unit.

### BACKGROUND OF THE INVENTION

(a) Field of the Invention

The present invention relates to an image browsing apparatus and a method thereof, and more particularly to a large size image browsing apparatus and a method thereof.

(b) Description of the Prior Art

With the vigorous development of science and technology, portable electronic devices have become increasingly diversified, such as mobile phones, personal digital assistants (PDAs), and the like electronic devices.

The screen sizes of the above-mentioned portable electronic devices are generally 240×320. When, for example, maps, WWW web pages and high resolution pictures are browsed, the sizes of these images are larger than a displayable size on the screen, so an image to be displayed cannot be completely and clearly displayed but only can be partially displayed on the screen. Current common modes of operation comprise the following: a first mode of scrolling along the X-axis or Y-axis, a second mode of dragging the image with a finger, and a third mode of Hawkeye navigation.

It may be convenient for the user to use the above three modes to browse normal size images (e.g. smaller than the size of 20000 pixels). However, it is inconvenient for the user to use a portable electronic device with a small screen to browse large size images (e.g. larger than the size of 20000 pixels). For example, in the first mode, the scroll will become too small to be selected, and there exists a problem that it is not easy to locate the scroll in a correct position. In the second mode, when the user desires to move a large size image from its most left side to its most right side, the user's finger must slide from left to right for nearly 80 times. Besides, if a WWW web page is dragged, the finger perhaps accidentally clicks on the other URL when in contact with the screen. Such incorrect operation would cause unnecessary communication fees. If the image is browsed in the third mode, a considerable deviation may occur in positioning due to the extreme ratio between the small picture viewed by Hawkeye navigation system and the actual picture.

### SUMMARY OF THE INVENTION

In view of the above-mentioned problems of the prior art, a primary object of the present invention is to provide a large size image browsing apparatus so that when the user moves the apparatus in space, a gravity sensor is used to calculate relative horizontal or vertical displacement of the apparatus and then calculate a new position or a new magnification of a displayed picture in the apparatus, so as to provide the user with the sensory effect of viewing a drawing paper with a magnifying glass.

According to the primary object of the present invention, a large size image browsing apparatus is provided, comprising a display unit, a sensing unit and a processing unit. The display unit displays a part of a large size image, and the size of the image is larger than a displayable size on the display unit. The sensing unit senses the force exerted on the browsing apparatus and calculates the displacement of the browsing apparatus to send out a displacement signal. The processing unit sends out a control signal according to the displacement signal, so as to control the display unit to update the part of the large size image.

For the convenience of operation by the user, the large size image browsing apparatus according to the present invention further comprises a switch, wherein the sensing unit sends out the displacement signal to the processing unit when the switch is turned on. Therefore, when the user browses a large size image via the display unit and needs to move from a certain position in the large size image to a new position relatively far away from the foregoing position, the operation can be performed by this switch.

The processing unit can send out the control signal according to movement information on the axes orthogonal to each other, so as to control the display unit to shift, reduce or enlarge the part of the image.

In order to reduce errors in operation, when a fluctuation magnitude of the force on one of the axes is less than a predetermined force threshold, the sensing unit ignores the force on this axis. Furthermore, when the ratio between fluctuation magnitudes of the forces on the two axes is less than a ratio threshold, the sensing unit ignores the force on the axis on which the fluctuation magnitude of the force is less than the other.

Moreover, the present invention provides a large size image browsing method applied to an apparatus comprising a display unit, a sensing unit and a processing unit, and the size of the image is larger than a displayable size on the display unit. The method according to the present invention comprises the following steps. First, the browsing apparatus is moved. Next, the sensing unit senses the force exerted on the browsing apparatus and calculates the displacement of the browsing apparatus to send out a displacement signal. Then, the processing unit sends out a control signal according to the displacement signal, so as to control the display unit to update a part of the large size image.

### BRIEF DESCRIPTION OF THE DRAWINGS

FIG. 1 is a block diagram of a large size image browsing apparatus according to the present invention;

FIG. 2 is a schematic view of a large size image browsing apparatus according to the present invention;

FIG. 3 is a graph of the forces on the three X-, Y- and Z-axes vs. time when a large size image browsing apparatus according to the present invention is moved back and forth along the Y-axis;

FIG. 4 is a flow chart of a large size image browsing method according to the present invention;

FIG. 5 is a schematic view of the operation of a large size image browsing apparatus according to the present invention; and

FIG. 6 is a schematic view of the operation of a large size image browsing apparatus according to the present invention.

### DETAILED DESCRIPTION OF THE PREFERRED EMBODIMENTS

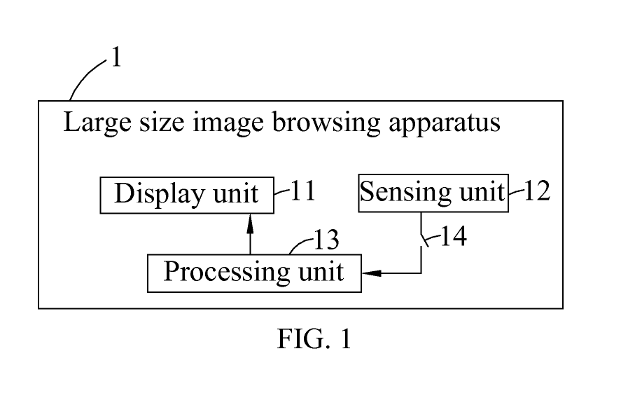

Referring to FIG. 1, a block diagram of a large size image browsing apparatus according to the present invention is illustrated. The large size image browsing apparatus 1 referred in this embodiment may be a mobile phone. In FIG. 1, the large size image browsing apparatus comprises a display unit 11, a sensing unit 12, a processing unit 13 and a switch 14. The size of a large size image 21 is larger than a displayable size on the display unit 11. The above components are described below.

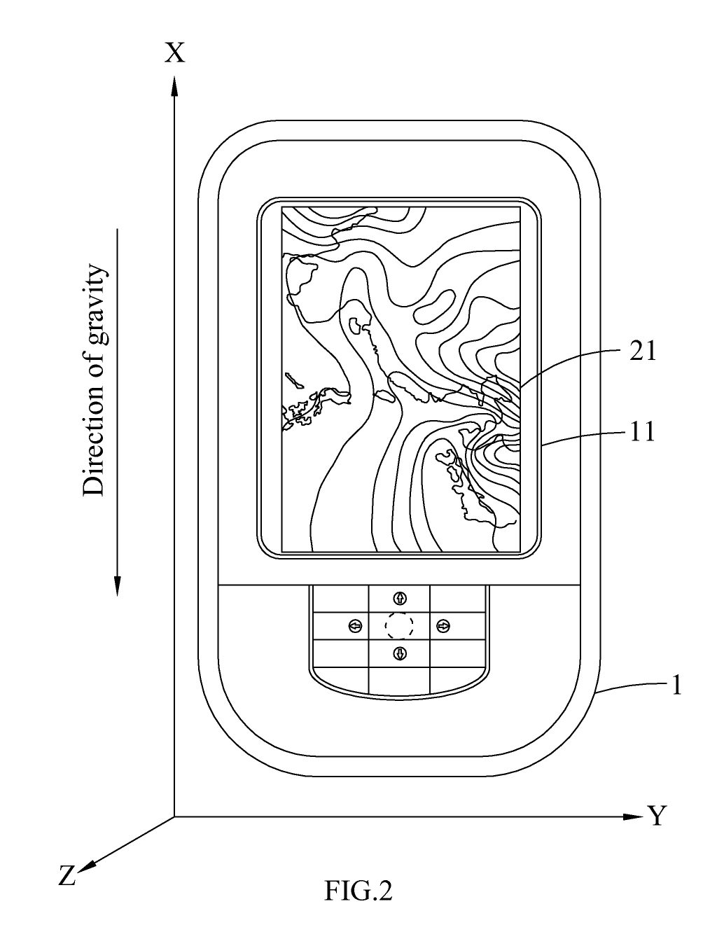

The display unit 11 may be a 240×320 screen, but the present invention is not limited thereto. It can display the large size image 21, as shown in FIG. 2.

The sensing unit 12 senses the motion of the large size image browsing apparatus 1 and calculates the displacement to send out a displacement signal. In this embodiment, the sensing unit 12 is preferably a three-dimensional gravity sensor, but the present invention is not limited thereto. Although a three-dimensional gravity sensor is a kind of widely used ICs in recent years, those skilled in the art should appreciate that the sensing unit could also be some other equivalent sensor in other embodiments.

The three-dimensional gravity sensor used in this embodiment is able to sense the force resulted from the large size image browsing apparatus 1 moved on three axes to calculate the displacement. The calculation principle is described below.

It is assumed that the large size image browsing apparatus 1 is placed upright in three-dimensional space, as shown in FIG. 2. When the browsing apparatus 1 is at rest, the values obtained by the three-dimensional gravity sensor always comprise a gravitational force but the supporting force that balances out the gravitational force is ignored. As a result, the gravitational force obtained when the browsing apparatus 1 is at rest can be directly taken out from calculated values of the force.

As described above, considering the gravitational force which is previously calculated when the browsing apparatus 1 is at rest and placed as shown in FIG. 2, the direction of gravity is the negative X-axis direction. The forces in the three directions of the X-axis, Y-axis and Z-axis obtained by the three-dimensional gravity sensor (comprising the gravitational force in the negative X-axis direction) are denoted by Fx′, Fy′ and Fz′, respectively, and then the gravitational force obtained when the browsing apparatus 1 is at rest is taken out therefrom to give Fx=Fx′-mg, Fy=Fy′-mg and Fz=Fz′-mg (where m is mass). The resultant force F on the browsing apparatus is:

F=\sqrt{Fx²+Fy²+Fz²}

According to Newton's second law of motion, when direction of an acceleration is the same as that of the resultant force, the acceleration of the object is directly proportional to the resultant force F exerted on the object but inversely proportional to the mass of the object. Hence, if the mass of the large size image browsing apparatus 1 is m, then the acceleration a of the large size image browsing apparatus 1 is:

a=F/m

Furthermore, the time interval between two adjacent sampling time points during the motion of the large size image browsing apparatus 1 is denoted by t, the initial velocity at the beginning of sampling is denoted by Vₙ, the final velocity at the end of sampling is denoted by Vₙ₊₁, and it is assumed that a running condition of the apparatus during the sampling time interval t is a uniform acceleration linear motion, that is, the acceleration remains constant. Thus, the relative displacement s can be obtained from the following equation:

$$s = {V}_{n} t + \frac{{at}^{2}}{2}$$

At the same time, the final velocity Vₙ₊₁ can be calculated by the following equation and used as the initial velocity in the next calculation.

Vₙ₊₁=Vₙ+at

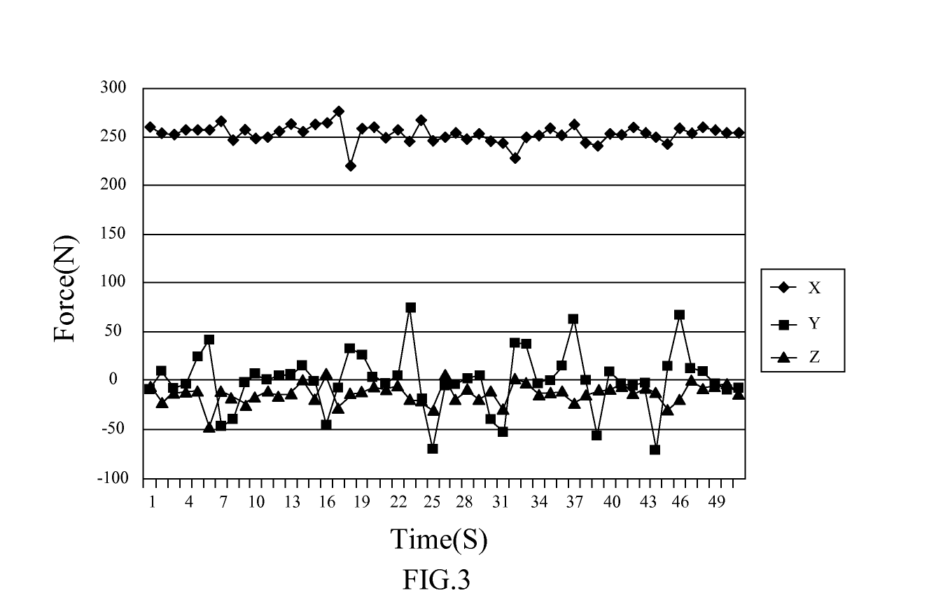

Referring to FIG. 3, illustrated is a graph of the forces on the three X-, Y- and Z-axes vs. time obtained by experimental measurement when the large size image browsing apparatus 1 according to the present invention is moved back and forth along the Y-axis. In order to simplify the process of sensing the motion of the browsing apparatus 1 for browsing the large size image 21 and calculating the displacement time by the sensing unit 12 in practical use, the sensing unit 12 in this embodiment can be further set with a ratio threshold to which the ratios of a fluctuation magnitude of the force exerted on the browsing apparatus 1 on the Y-axis to fluctuation magnitudes of the forces on the X-axis (a gravitational factor is comprised in the graph of FIG. 3) and the Z-axis are compared. The fluctuation magnitude of the force on the Y-axis refers to the absolute value of the difference obtained by subtraction of the force on the Y-axis at a second predetermined time from the force on the Y-axis at a first predetermined time. The difference between the first predetermined time and the second predetermined time may be 5 seconds, but this is not limitative, and the difference between the first predetermined time and the second predetermined time may be an arbitrary predetermined time interval. Moreover, the fluctuation magnitude of the force on the Z-axis can be obtained in a similar manner and will be explained in no more detail. As shown in FIG. 3, when the ratios of fluctuation magnitudes of the forces exerted on the browsing apparatus 1 on the X-axis and the Z-axis to a fluctuation magnitude of the force on the Y-axis are less than the ratio threshold, the forces on the X-axis and the Z-axis can be ignored. It is considered that the browsing apparatus 1 is moved along the Y-axis (horizontal direction), namely, the large size image 21 displayed on the display unit 11 can be moved in the left and right directions.

Moreover, in order to reduce operating errors by the user, the sensing unit 12 can be further set with a force threshold. When one of the forces exerted on the browsing apparatus 1 on the X-, Y- and Z-axes is less than the force threshold, the sensing unit 12 ignores the force on one of the X-, Y- and Z-axes and calculates the displacement directly from the forces on the other two axes to send out a displacement signal.

The processing unit 13 then sends out a control signal according to the displacement signal sent out by the sensing unit 12 to update the large size image 21 on the display unit 11. In this embodiment, updating the large size image 21 can be enlarging the large size image 21, reducing the large size image 21, or shifting the large size image 21.

The switch 14 is electrically connected to the sensing unit 12 and the processing unit 13. When the switch 14 is turned on, the sensing unit 12 sends out the displacement signal to the processing unit 13. In this embodiment, the switch 14 is preferably a button switch, i.e. a button switch on a common portable electric device. The user can operate the switch in a conventional manner. It is simple and easy to handle, like the operation of a common button switch of a mobile phone. The button is pressed when the device is moved toward a desired position, and the button switch is released when it is moved in the opposite direction. This can achieve the purpose of continuously moving an image toward one direction. Namely, if an image effect the user desires has not been achieved when the portable electric device is moved to a position at the farthest distance from the user, the button switch is released while it is temporarily moved in the opposite direction and then the button is pressed when it is moved toward the desired position again, so as to move an image to a new position the user desires. Furthermore, if it is found that the image is moved beyond the desired new position, it only needs not to release the button switch when the device is moved in the opposite direction, so as to move the image back to the original desired new position.

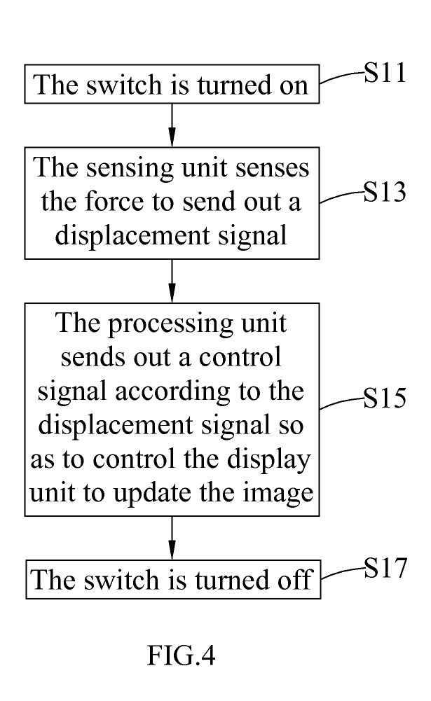

Referring to FIG. 4, a flow chart of a large size image browsing method according to the present invention is illustrated. Also referring to FIG. 1, the large size image browsing method according to the present invention is applied to a large size image browsing apparatus 1. The large size image browsing apparatus 1 also has the foregoing components and will be explained in no more detail.

The large size image browsing method in this embodiment comprises the following steps. First, in step S11, the user turns on the switch 14. In step S13, the sensing unit 12 of the large size image browsing apparatus 1 senses the motion itself to send out a displacement signal. In step S15, the processing unit 13 sends out a control signal according to the displacement signal to update the large size image on the display unit 11. In step S17, the switch 14 is turned off.

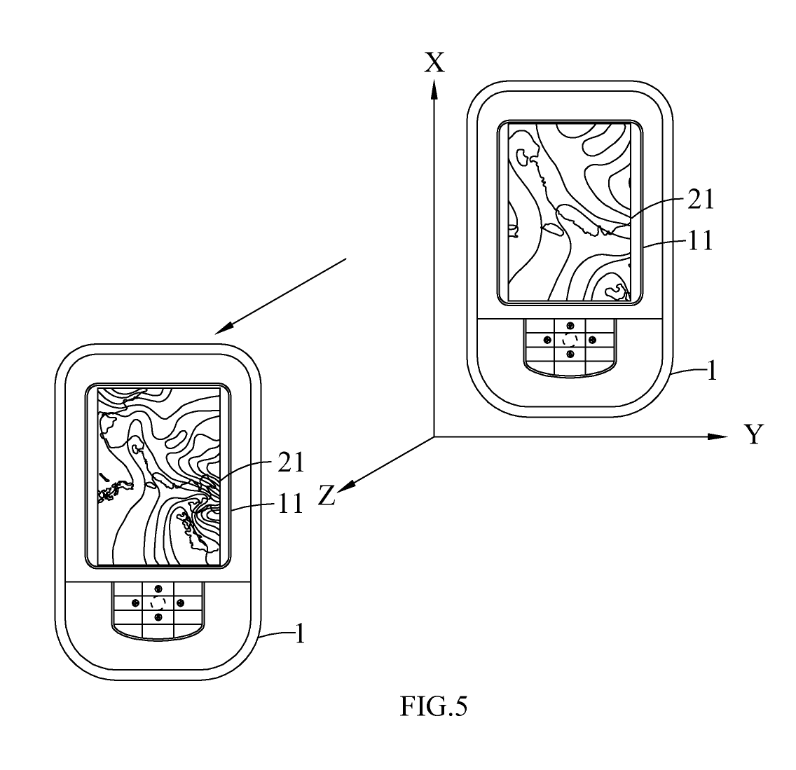

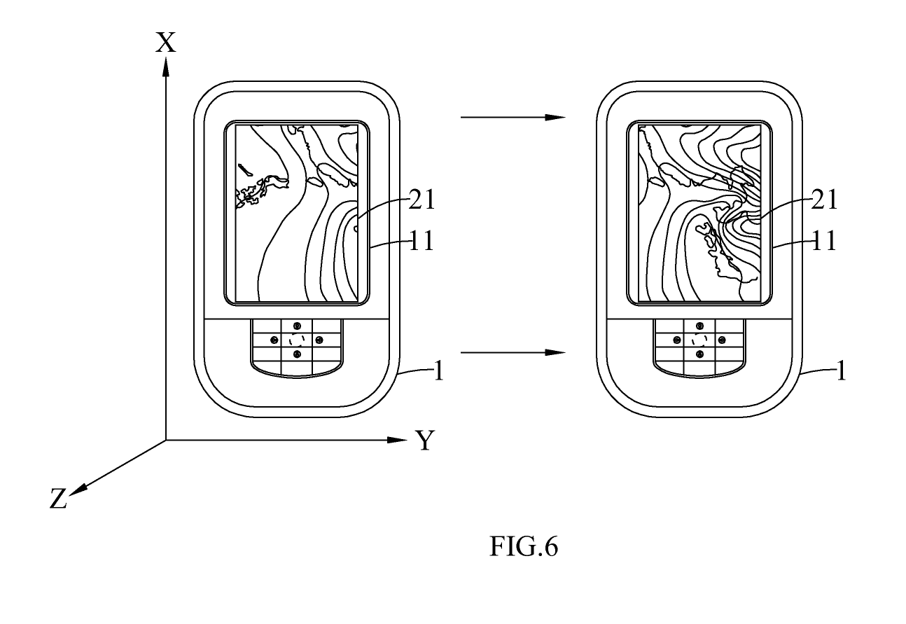

For example, the user can press the button switch before moving the large size image browsing apparatus 1. Next, as shown in FIG. 5, the three-dimensional gravity sensor senses the motion of the large size image browsing apparatus 1 along the Z-direction and calculates the displacement, and then the processing unit 13 sends out a control signal according to the displacement signal sent out by the sensing unit 12 to enlarge the large size image 21 on the display unit 11. Thereafter, if the user presses the button switch again and subsequently the three-dimensional gravity sensor senses the motion of the large size image browsing apparatus 1 along the Y-direction, then the large size image 21 can be shifted on the display unit 11, as shown in FIG. 6.

In the above-mentioned embodiment, the three-dimensional gravity sensor is used to obtain the forces in the three directions of the X-axis, Y-axis and Z-axis, and a force threshold for fluctuation magnitudes of the forces is set, whereby the main direction of movement of the large size image browsing apparatus 1 is found out to achieve the purpose of reducing operating errors by the user. Furthermore, the large size image browsing apparatus 1 in this embodiment can directly use upward single or a plurality of displacement values of three axes to allow real-time movement to a new position the user desires by adopting the design combination of the display unit 11 having a three-dimensional dynamic display function and the processing unit 13 that can provide control signals of displacement on the three axes to the display unit 11, without setting any force thresholds for a fluctuation magnitude of the forces. Accordingly, the present invention can be achieved.

The above description is illustrative only and is not to be considered limiting. Various modifications or changes can be made without departing from the spirit and scope of the invention. All such equivalent modifications and changes shall be comprised within the scope of the appended claims.

What is claimed is:

1. A large size image browsing apparatus comprising:
a display unit displaying a part of a large size image, wherein a size of the large size image is larger than a displayable size on the display unit;
a sensing unit sensing a force exerted on the browsing apparatus and accordingly calculating displacement of the browsing apparatus to send out a displacement signal; and
a processing unit sending out a control signal according to the displacement signal, so as to control the display unit to update the part of the large size image.

2. The large size image browsing apparatus as defined in claim 1, further comprising a switch, wherein the sensing unit sends out the displacement signal to the processing unit when the switch is turned on.

3. The large size image browsing apparatus as defined in claim 1, wherein the sensing unit is a gravity sensor.

4. The large size image browsing apparatus as defined in claim 1, wherein the sensing unit senses the forces exerted on the browsing apparatus on a first axis and a second axis and accordingly calculates the displacement of the browsing apparatus to send out the displacement signal that comprises movement information on the first axis and the second axis, wherein the first axis and the second axis are orthogonal to each other.

5. The large size image browsing apparatus as defined in claim 4, wherein the sensing unit ignores the force on the first axis or the second axis when a fluctuation magnitude of the force on the first axis or the second axis is less than a force threshold, wherein the fluctuation magnitude of the force is an absolute value of difference between the force on the first axis or the second axis at a first predetermined time and the force on the first axis or the second axis at a second predetermined time.

6. The large size image browsing apparatus as defined in claim 4, wherein the processing unit sends out the control signal according to the movement information on the first axis and the second axis, so as to control the display unit to shift, reduce or enlarge the part of the large size image.

7. The large size image browsing apparatus as defined in claim 6, wherein the sensing unit ignores the force on the first axis or the second axis when a fluctuation magnitude of the force on the first axis or the second axis is less than a force threshold, wherein the fluctuation magnitude of the force is an absolute value of difference between the force on the first axis or the second axis at a first predetermined time and the force on the first axis or the second axis at a second predetermined time.

8. The large size image browsing apparatus as defined in claim 4, wherein the sensing unit ignores the force on the first axis when a ratio of a fluctuation magnitude of the force on the first axis to a fluctuation magnitude of the force on the second axis is less than a ratio threshold, wherein the fluctuation magnitude of the force on the first axis is an absolute value of difference between the force on the first axis at a first predetermined time and the force on the first axis at a second predetermined time, the fluctuation magnitude of the force on the second axis is an absolute value of difference between the force on the second axis at the first predetermined time and the force on the second axis at the second predetermined time.

9. The large size image browsing apparatus as defined in claim 8, wherein the sensing unit ignores the force on the first axis or the second axis when the fluctuation magnitude of the force on the first axis or the fluctuation magnitude of the force on the second axis is less than a force threshold.

10. The large size image browsing apparatus as defined in claim 1, wherein the display unit further comprising a three-dimensional dynamic display function displays the large size image moved in three-dimensional space according to a three-dimensional control signal from the processing unit in real time.

11. A large size image browsing method applied to a large size image browsing apparatus comprising a display unit displaying a part of a large size image, a sensing unit and a processing unit, a size of the large size image being larger than a displayable size on the display unit, the method comprising the following steps:
(A) moving the browsing apparatus;
(B) calculating displacement of the browsing apparatus by the sensing unit sensing a force exerted on the browsing apparatus so as to send out a displacement signal; and
(C) sending out a control signal by the processing unit according to the displacement signal, so as to control the display unit to update the part of the large size image.

12. The large size image browsing method as defined in claim 11, wherein the browsing apparatus further comprises a switch which is electrically connected to the sensing unit and the processing unit so that the method further comprises a step (A1) turning on the switch prior to the step (B).

13. The large size image browsing method as defined in claim 12, wherein the method further comprises a step (D) turning off the switch after the step (C).

14. The large size image browsing method as defined in claim 11, wherein the sensing unit is a gravity sensor.

15. The large size image browsing method as defined in claim 11, wherein the sensing unit senses the forces exerted on the browsing apparatus on a first axis and a second axis and accordingly calculates the displacement of the browsing apparatus to send out the displacement signal that comprises movement information on the first axis and the second axis, wherein the first axis and the second axis are orthogonal to each other.

16. The large size image browsing method as defined in claim 15, wherein the processing unit sends out the control signal according to the movement information on the first axis and the second axis, so as to control the display unit to shift, reduce or enlarge the part of the large size image.

17. The large size image browsing method as defined in claim 15, wherein the sensing unit ignores the force on the first axis or the second axis when a fluctuation magnitude of the force on the first axis or the second axis is less than a force threshold, wherein the fluctuation magnitude of the force is an absolute value of difference between the force on the first axis or the second axis at a first predetermined time and the force on the first axis or the second axis at a second predetermined time.

18. The large size image browsing method as defined in claim 15, wherein the sensing unit ignores the force on the first axis when a ratio of a fluctuation magnitude of the force on the first axis to a fluctuation magnitude of the force on the second axis is less than a ratio threshold, wherein the fluctuation magnitude of the force on the first axis is an absolute value of difference between the force on the first axis at a first predetermined time and the force on the first axis at a second predetermined time, the fluctuation magnitude of the force on the second axis is an absolute value of difference between the force on the second axis at the first predetermined time and the force on the second axis at the second predetermined time.

19. The large size image browsing method as defined in claim 18, wherein the sensing unit ignores the force on the first axis or the second axis when the fluctuation magnitude of the force on the first axis or the fluctuation magnitude of the force on the second axis is less than a force threshold.

20. The large size image browsing method as defined in claim 11, wherein the display unit further comprising a three-dimensional dynamic display function displays the large size image moved in three-dimensional space according to a three-dimensional control signal from the processing unit in real time.
